(19) United States
(12) Patent Application Publication
(10) Pub. No.: US 2014/0068103 A1
(43) Pub. Date: Mar. 6, 2014

(54) STATEFUL FAILOVER MANAGEMENT IN A NETWORK TRAFFIC MANAGER

(71) Applicant: F5 Networks, Inc., Seattle, WA (US)

(72) Inventors: Raghu Menzo Gyambavantha, Erie, CO (US); Manish Vachharajani, Lafayette, CO (US); John Giacomoni, Longmont, CO (US); Mark Terrel, Denver, CO (US)

(73) Assignee: F5 Networks, Inc., Seattle, WA (US)

(21) Appl. No.: 13/970,478

(22) Filed: Aug. 19, 2013

Related U.S. Application Data
(60) Provisional application No. 61/684,651, filed on Aug. 17, 2012.

(51) Int. Cl. H04L 12/801

(52) U.S. Cl. CPC H04L 47/10
USPC 709/238

(57) ABSTRACT

Methods, systems, and devices are described for stateful failover in traffic manager module functioning as a proxy between at least one first network device and at least one server. In a first set of embodiments, an amount of synchronized state information may be reduced through a controlled use of acknowledgment messages. In a second set of embodiments, state information may be synchronized to a standby traffic manager module in response to changes in a sequence number delta between two logically paired connections. In a third set of embodiments, connections may be restored at a standby traffic manager module based on stored connection information, a synchronized sequence number delta stack, and rediscovered sequence numbers.

### CROSS-REFERENCE TO RELATED APPLICATION

The present application claims priority to U.S. Provisional Application No. 61/684,651, entitled “STATEFUL FAILOVER MANAGEMENT IN A NETWORK TRAFFIC MANAGER,” filed Aug. 17, 2012, the entire disclosure of which is incorporated herein by reference for all purposes.

### BACKGROUND

The present invention relates to network traffic management, and more particularly, to the controlled optimization of network traffic using a proxy network traffic manager module.

Proxies are often used as network agents to improve network performance and increase efficiency. A proxy may split a connection between two network devices such that the proxy appears to be the second network device from the point of view of the first network device and appears to be the first network device from the point of view of the second network device. Thus, a proxy may establish separate connections with the network devices and forward communications between the network devices over the separate connections. A performance enhancing proxy (PEP) may take certain actions with respect to the connections such as spreading out requests to a service across multiple servers implementing that service.

Some system utilizing proxies may incorporate redundant proxies into the network as a protection against failover. In the event that a primary proxy fails, a redundant proxy may take over some or all of the network connections of the primary proxy. However, the implementation of failover protection through redundant proxies traditionally requires the synchronization of large amounts of state information for each of the connections between the primary proxy and the redundant proxy. This synchronization may consume the resources of the primary proxy and reduce the performance and throughput of the primary proxy.

### SUMMARY

Methods, systems, and devices are described for stateful failover in traffic manager module functioning as a proxy between at least a first network device and a second network device.

According to at least a first set of illustrative embodiments, a method of managing network communications may include receiving a packet from a first network device at a traffic manager module serving as a proxy to a second network device for the first network device; forwarding data from the packet to the second network device; and delaying transmitting an acknowledgment of the packet from the traffic manager module to the first network device until after the traffic manager module has received an acknowledgment of the data by the second network device.

In certain examples, the traffic manager module may be a first traffic manager module that synchronizes with a second traffic manager module. The first traffic manager module may track a sequence number delta between a first connection with the first network device and a second connection with a second network device. The first traffic manager module may detect a change in the sequence number delta and synchronize a state of the first traffic manager module with the second traffic manager module in response to the detected change in the sequence number delta. Additionally or alternatively, the state of the first traffic manager module may be synchronized with the second traffic manager module in response to one or more of: a rollover of a sequence number of one of the connections to an initial value or a change in a connection state of one of the connections.

In certain examples, a stack of sequence number deltas between the first connection and the second connection at the first traffic manager module may be stored, and synchronizing the state of the first traffic manager module with the second traffic manager module may include synchronizing the stack of sequence number deltas with the second traffic manager module.

In certain examples, the first traffic manager module may refraining, in response to the change in the sequence number delta, from forwarding data between the first network device and the second network device until the state of the first traffic manager module has been synchronized with the state of the second traffic manager module.

In certain examples, a logical coupling between the first connection and the second connection may be stored at the first traffic manager module. Synchronizing the state of the first traffic manager module with the second traffic manager module may include synchronizing the logical coupling between the first connection and the second connection with the second traffic manager module.

In certain examples, Quality of Service (QoS) information related to the first connection and the second connection may be stored at the first traffic manager module, and synchronizing the state of the first traffic manager module with the second traffic manager module may include synchronizing the QoS information related to the first connection and the second connection with the second traffic manager module.

According to a second set of illustrative embodiments, a traffic manager module may include at least one processor and a memory communicably coupled with the at least one processor. The memory may be configured to store code that, when executed by the at least one processor, causes the at least one processor to receive a packet from a first network device, the traffic manager module serving as a proxy to a second network device for the first network device; forward data from the packet to the second network device; and delay transmitting an acknowledgment of the packet from the traffic manager module to the first network device until after the traffic manager module has received an acknowledgment of the data by the second network device.

In certain examples, the code may cause the at least one processor to implement one or more aspects of the method described above with respect to the first set of illustrative embodiments.

According to a third set of illustrative embodiments, a computer program product may include a tangible computer-readable medium comprising computer-readable program code stored thereon. The computer-readable program code may be configured to cause at least one processor to receive a packet from a first network device at a traffic manager module serving as a proxy to a second network device for the first network device; forward data from the packet to the second network device; and delay transmitting an acknowledgment of the packet from the traffic manager module to the first network device until after the traffic manager module has received an acknowledgment of the data by the second network device.

In certain examples, the computer-readable program code may be configured to cause the at least one processor to implement one or more aspects of the method described above with respect to the first set of illustrative embodiments.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example network incorporating redundant proxy traffic manager modules according to various embodiments of the invention.

FIG. 2 is a block diagram of network connections maintained by an example traffic manager module in a network system according to various embodiments of the invention.

FIG. 3 is a block diagram of an example of controlling acknowledgment messages at a principal traffic manager module to reduce an amount of state data synchronized to a redundant standby traffic manager module according to various embodiments of the invention.

FIG. 4 is a block diagram of an example traffic manager module according to various embodiments of the invention.

FIG. 5A is a flowchart diagram of an example method of managing traffic in a traffic manager module according to various embodiments of the invention.

FIG. 5B is a flowchart diagram of an example method of managing traffic in a traffic manager module according to various embodiments of the invention.

FIGS. 6A-6D are diagrams illustrating an example synchronization scenario at a principal traffic manager module of a network according to various embodiments of the invention.

FIG. 7 is a diagram of example synchronization data exchanged between a principal traffic manager module and a redundant standby traffic manager module of a network according to various embodiments of the invention.

FIG. 8 is a block diagram of an example traffic manager module according to various embodiments of the invention.

FIG. 9 is a flowchart diagram of an example method of managing traffic in a traffic manager module according to various embodiments of the invention.

FIG. 10 is a block diagram of an example traffic manager module according to various embodiments of the invention.

FIG. 11 is a flowchart diagram of an example method of managing traffic in a traffic manager module according to various embodiments of the invention.

FIG. 12 is a schematic diagram that illustrates a representative device structure that may be used in various embodiments of the present invention.

### DETAILED DESCRIPTION OF THE INVENTION

Methods, systems, and devices are described for stateful failover in traffic manager module functioning as a proxy between at least a first network device and a second network device. In a first set of embodiments, an amount of synchronized state information may be reduced through a controlled use of acknowledgment messages. In a second set of embodiments, state information may be synchronized to a standby traffic manager module in response to changes in a sequence number delta between two logically paired connections. In a third set of embodiments, connections may be restored at a standby traffic manager module based on stored connection information, a synchronized sequence number delta stack, and rediscovered sequence numbers.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

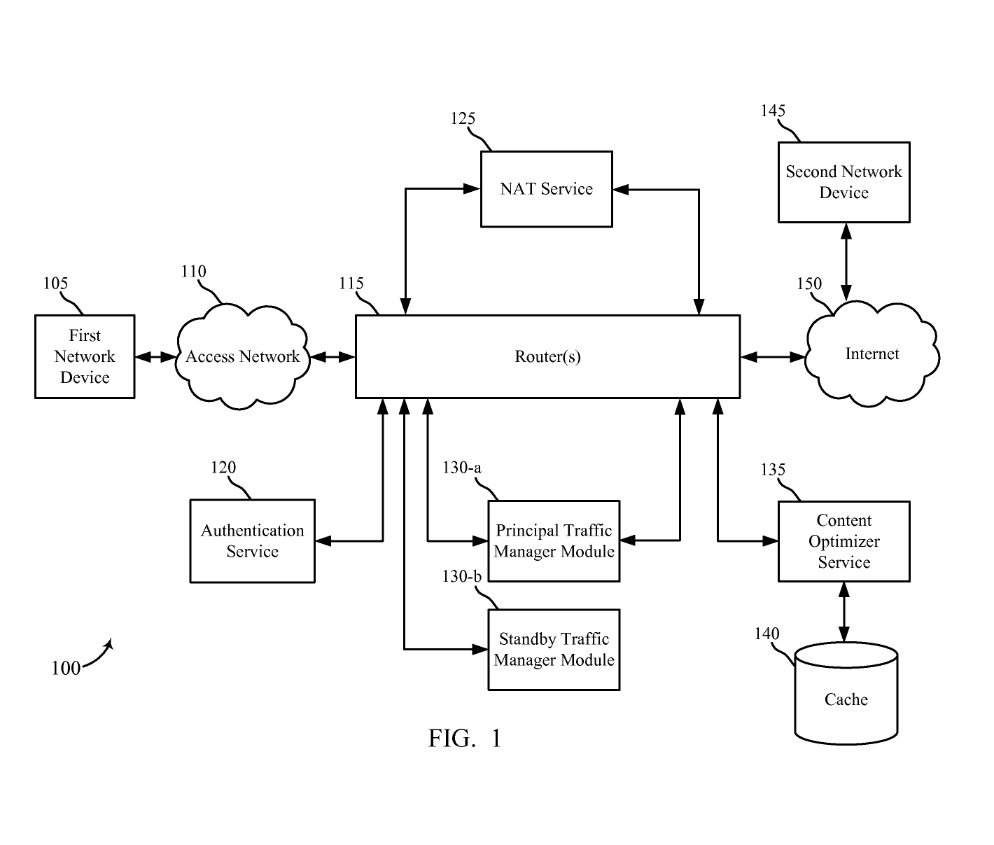

FIG. 1 is a block diagram of an example of a network system 100 incorporating a traffic manager module 130 that operates as a proxy to enhance network performance. The system 100 of the present example may include a first network device 105, an access network 110, one or more network routers 115, an authentication service 120, a Network Address Translation (NAT) service, the traffic manager module 130, at least one content optimizer service 135, a content cache 140, and a second network device 145 available over a connection to the Internet 150 or another packet data network. Each of the services 120, 125, 135 of FIG. 1 may be implemented by one or more network devices (e.g., servers). Each of the components of FIG. 1 may be in communication with the other components, directly or indirectly.

In certain examples, the first network device 105 may be a mobile device and the access network 110 may be a radio access network, but the principles of the present description are not limited to such embodiments. Those having skill in the art will recognize that other types of devices and networks may be used. Similarly, the inventive principles of the present description are not limited to systems including an authentication service 120 or a NAT service 125. Rather, additional or alternate services or network devices may be used as may suit a particular application of the principles described herein. In certain examples, one or more of the authentication service 120, the NAT service 125, or the content optimizer service 135 may be subsumed into the traffic manager module 130.

The traffic manager module 130 may serve as a proxy between the first network device 105 and the second network device 145. In the present example, the first network device 105 may attempt to access the Internet 150 and/or one of the services 120, 125, 135, but may not be granted access until the authentication service 120 confirms that an account or user associated with the first network device 105 is authorized to access the network. In certain examples, this authorization may be based on an identity of the first network device 105. Additionally or alternatively, the authorization may be based on one or more authentication credentials provided by the first network device 105 to authenticate the identity of a user of the first network device 105.

Once the authentication service 120 has authenticated the first network device 105, the first network device 105 may be permitted to send messages requesting network objects (e.g., files, web pages, etc.) or access other services over the network. The router(s) 115 may be configured such that certain messages from the first network device 105 received over the access network 110 may be sent to the traffic manager module 130 and other types of messages may be sent to the NAT service 125. For example, the router(s) 115 may be configured to direct all messages from the first network device 105 that are associated with Transport Control Protocol (TCP) port 80 to the traffic manager module 130. Other types of messages from the first network device 105 may be routed directly to the NAT service 125 for resolution and further routing to, for example, the second network device 145.

It will be understood that the authentication service 120 of the present example may at any time insert or update the credentials and policies associated with a user. Additionally or alternatively, the traffic manager module 130 may request updated credentials and policies from the authentication service 120 at any time.

The traffic manager module 130 may be configured to act as a proxy with respect to certain messages issued by the first network device 105. Thus, the traffic manager module 130 may establish a connection (e.g., TCP sessions) with the first network device 105. The traffic manager module 130 may also establish connections with the second network device 145 on behalf of the first network device 105. In certain examples, the traffic manager module 130 may be implemented by hardware executing special-purpose code. For example, the traffic manager module 130 may be implemented by a server running special-purpose software. Alternatively, the traffic manager module 130 may be implemented entirely by hardware.

By acting as a proxy, the principal traffic manager module 130-a may take performance enhancing actions to optimize the processing of requests from the first network device 105 and responses to those requests from the second network device 145. Thus, the principal traffic manager module 130-a may receive incoming TCP or other layer 4 packets related to a request from the first network device 105 or a response to such a request from the second network device. In certain examples, the principal traffic manager module 130-a may analyze the application layer (layer 7) content of these received packets and take certain actions with respect to one or more connections or objects based on the analysis of the application layer content and a set of rules enforced by the principal traffic manager module 130-a. Additionally or alternatively, the performance enhancing actions may be taken based on non content-specific triggers (e.g., rules, timers, etc.) or on a per-transaction basis.

The standby traffic manager module 130-b may be configured to implement substantially the same proxy functionality as the principal traffic manager module 130-a. In certain examples, the standby traffic manager module 130-b may provide failover protection for the principal traffic manager module 130-a. Thus, in the event that the principal traffic manager module 130-a fails, the standby traffic manager module 130-b may take over open connections that were held by the principal traffic manager module 130-a and maintain proxy services for those open connections.

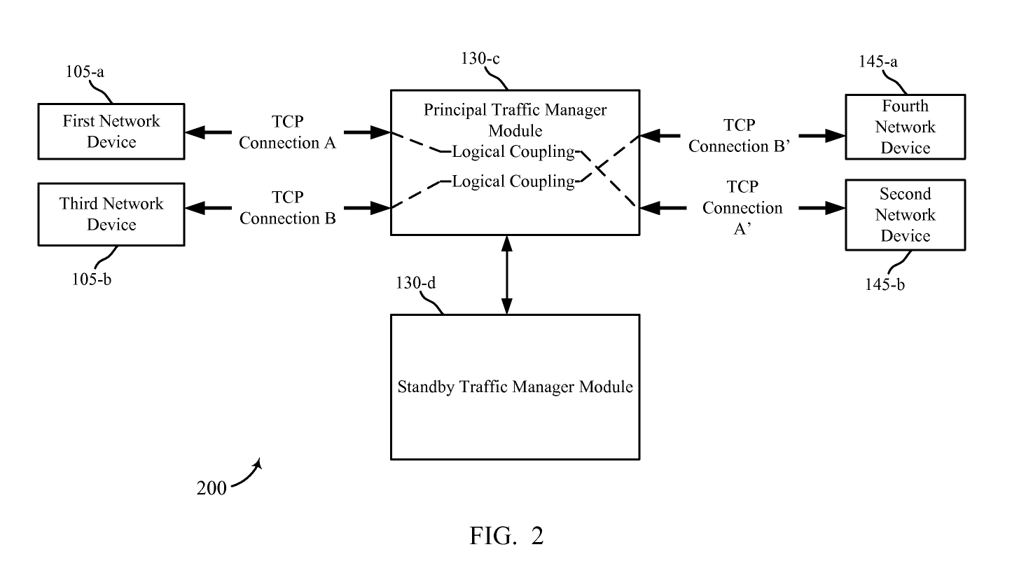

FIG. 2 is a block diagram of an example system 200 in which a principal traffic manager module 130-c may act as a proxy between a first network device 105-a and a second network device 145-b and between a third network device 105-b and a fourth network device 145-a. The system 200 may be an example of the system 100 described above with reference to FIG. 1. The network devices may be implemented by one or more computer or server devices in communication with the principal traffic manager module 130-c over a network.

In the example of FIG. 2, the principal traffic manager module 130-c may establish a first Transport Control Protocol TCP connection (“Connection A”) with the first network device 105-a and a second TCP connection (“Connection A′”) with the second network device 145-b. The principal traffic manager module may logically couple Connection A and Connection A′ together such that the principal traffic manager module 130-c acts as a proxy for communications between the first network device 105-a and the second network device 145-b. Similarly, the principal traffic manager module 130-c may establish a third TCP connection (“Connection B”) with the third network device 105-b and a fourth TCP connection (“Connection B′”) with the fourth network device 145-a. Connection B and Connection B′ may be logically coupled such that the principal traffic manager module 130-c acts as a proxy for communications between the third network device 105-b and the fourth network device 145-a.

As in FIG. 1, a standby traffic manager module 130-d may be configured to redundantly provide the same proxy functionality as the principal traffic manager module 130-a as failover protection for the principal traffic manager module 130-a. Thus, if the principal traffic manager module 130-a fails, the standby traffic manager module 130-b may take over open connections that were held by the principal traffic manager module 130-a and maintain proxy services for those open connections.

One challenge associated with providing redundant failover protection for proxy connections is that the state of each open connection at the principal traffic manager module 130-c must be known at the standby traffic manager module 130-b in order to take over that connection and keep the connection alive. If the state information for a connection is not known at the standby traffic manager module 130-d at the time of failover, the standby traffic manager module 130-d may not have sufficient information to recreate the connection, and the connection may be dropped. State information for the example TCP connections shown in FIG. 2 may include basic information about each TCP socket (e.g., IP address, port number) in the connection, information about negotiated session parameters (e.g., window scaling, time stamps, maximum segment size, etc.), a current TCP socket state (e.g., active, closed, etc.), sequence number information, and information about application specific data and its size. Additionally, the state information may include the contents of packets held in a buffer for transmission over the connection for which acknowledgment of receipt has not been received.

Because the state information of a TCP connection includes the current sequence number and the contents of packets held in a buffer for transmission over the connection, traditional failover approaches synchronize all state information between redundant proxies each time a packet is received or buffered for transmission. Because synchronization of state information may occur so frequently and include large quantities of data, traditional synchronization may consume a significant amount of time and processing resources at the primary and standby traffic manager modules 130. However, the present description discloses systems, methods, and devices for reducing both the amount of state information synchronized and the frequency of state information synchronization in a proxy environment. By reducing the amount of state information synchronized and the frequency of state information, fewer resources may be occupied at the primary and standby traffic manager modules 130 to preserve connection state information. Accordingly, features of failover protection may be implemented more economically and in a more scalable fashion than traditionally.

Controlled Acknowledgment Messages to Reduce Synchronized State Information

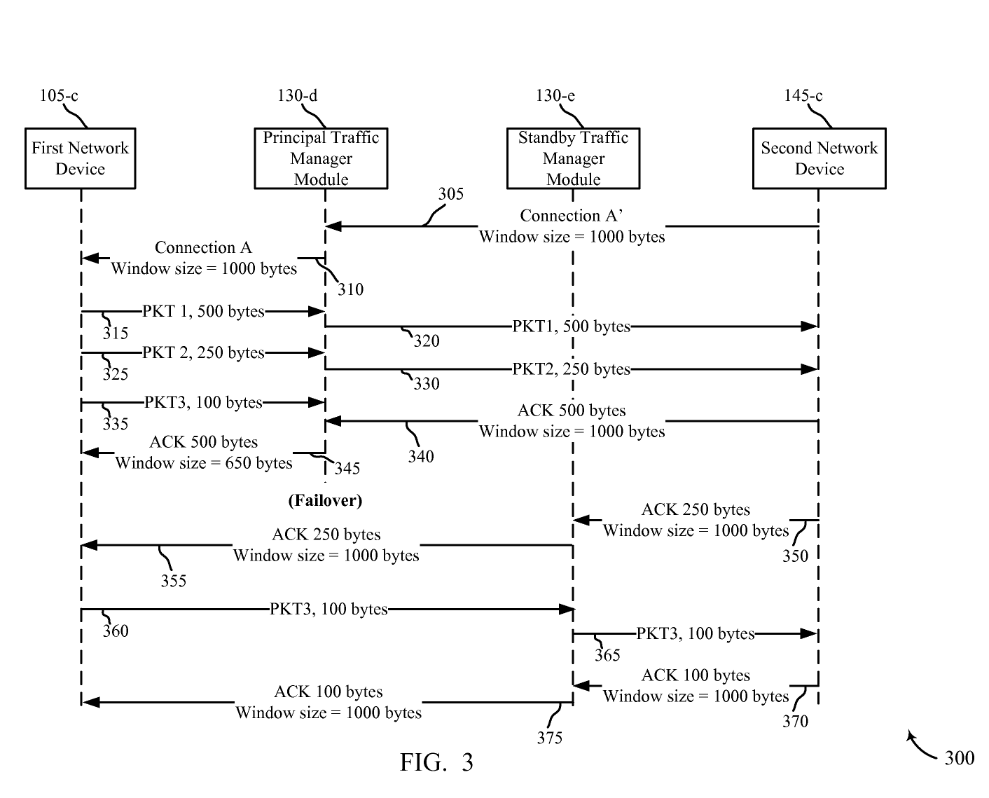

FIG. 3 is a block diagram of the use of controlled acknowledgement messages in a system 300 to reduce the amount of state data synchronized between a principal traffic manager module 130-d and a standby traffic manager module 130-e. The system 300 of FIG. 3 may be an example of the systems 100, 200 described above with reference to the previous Figures. In the system 300 of FIG. 3, the principal traffic manager module 130-d may establish an initial TCP connection (“Connection A”) with a first network device 105-c and an initial TCP connection (“Connection A′”) with a second network device 145-c. In other examples, other types of connections may be used. The principal traffic manager module 130-d may act as a proxy between the first network device 105-c and the second network device 145-c such that data may be exchanged between the first network device 105-c and the second network device 145-c via the principal traffic manager module 130-d over Connection A and Connection A′.

In TCP and other types of network connections, a first socket may transmit data to a second socket in one or more packets, and then wait for an acknowledgment message from the second socket indicating that the data has been received and buffered at the second socket. The first socket may maintain a buffer of the sent data such that if no acknowledgment message is received from the second socket after a specified timeout period, the first socket may retransmit the sent data to the second socket. This functionality may be exploited to reduce the amount of state data synchronized between the principal traffic manager module 130-d and the standby traffic manager module 130-e through the careful timing of acknowledgment messages by the principal traffic manager module 130-d.

In the example of FIG. 3, the first network device 105-c may have data to transmit to the second network device 145-c. The second network device 145-c may advertise 305 a window size indicating the amount of data the second network device 145-c is able to receive over Connection A′ to the principal traffic manager module 130-d. In the present example, the second network device 145-c may advertise a window size of 1000 bytes. Acting as proxy, the principal traffic manager module 130-d may advertise 310 the same window size to the first network device 105-c. The principal traffic manager may alternatively choose to advertise a different window size to the client. The first network device 105-c may then transmit 315 packet #1 over Connection A to the principal traffic manager module 130-d. In a traditional system, the principal traffic manager module 130 may immediately respond with an acknowledgement message for packet #1. However, in the system of FIG. 3, the principal traffic manager module 130-d delays transmitting the acknowledgment message for packet #1 to the first network device 105-c until after the principal traffic manager module 130-d has forwarded 320 packet #1 to the second network device 145-c over Connection A′ and received 340 an acknowledgment message for packet #1 from the second network device 145-c. In the meantime, the first network device 105-c may transmit 325 packet #2 and transmit 335 packet #3 to the principal traffic manager module 130-d. The principal traffic manager module 130-d may forward 330 packet #2 to the second network device 145-c. Once the acknowledgment message for packet #1 has been received 340 from the second network device 145-c for packet #1, the principal traffic manager module 130-d may transmit 345 an acknowledgment message for packet #1 to the first network device 105-c. Similarly, the principal traffic manager module 130-d may delay transmitting an acknowledgment message for packet #3 to the first network device 105-c until after an acknowledgment message has been received 350 for packet #3 from the second network device 145-c.

By delaying the transmission of acknowledgment messages to the first network device 105-c until after a corresponding acknowledgment message has been received from the second network device 145-c, the principal traffic manager module 130-d need not buffer the packets received from the first network device 105-c after forwarding those packets to the second network device 145-c, as the first network device 105-c will automatically retransmit packets for which no acknowledgment is received from the principal traffic manager module 130-d. Because the principal traffic manager module 130-d does not need to buffer the packets received from the first network device 105-c the principal traffic manager module 130-d need not synchronize state data for buffered packets to the standby traffic manager module 130-e or notify the standby traffic manager module every single time the state of Connection A′ at the principal traffic manager module 130-d changes state.

This concept is illustrated in FIG. 3 with the failure of the principal traffic manager module 130-d after receiving packet #2 and packet #3 and before the principal traffic manager module 130-d is able to forward the data from packet #3 to the second network device 145-c. Upon the failure of the principal traffic manager module 130-d, Connection A and Connection A′ may be taken over by the standby traffic manager module 130-e. The standby traffic manager module 130-e may receive 350 an acknowledgment message for packet #2 and transmit 355 an acknowledgment message for packet #2 to the first network device 105-c. After the timeout period for receiving an acknowledgment for packet #3 has expired, the first network device 105-c may retransmit 360 packet #3 to the standby traffic manager module 130-e, and the standby traffic manager module 130-e may forward 365 the data from packet #3 to the second network device 145-c. Upon receiving 370 an acknowledgment message for packet #3 from the second network device 145-c, the standby traffic manager module 130-e may transmit 375 an acknowledgment message for packet #3 to the first network device 105-c.

The principal traffic manager module 130-d may maintain a record of a current sequence number delta in each direction of communication between Connection A and Connection A′ to allow the principal traffic manager module 130-d to convert packets received from the first network device 105-c into packets for transmission to the second network device 145-c and vice versa. Additionally, to enable uninterrupted application processing and failover without synchronizing unacknowledged data transmitted to the second network device 145-c with the standby traffic manager module 130-e, the principal traffic manager module 130-d may maintain a stack of past sequence number deltas created due to transformation on the application data. This stack may be synchronized between the principal traffic manager module 130-d and the standby traffic manager module 130-e such that every time the sequence number delta changes, the standby traffic manager module 130-e receives an updated copy of the sequence number delta stack. Additionally, the stack may be synchronized between the principal traffic manager module 130-d and the standby traffic manager module 130-e each time the sequence number of the principal traffic manager module 130-d or the standby traffic manager module 130-e rolls over to an initial value. When the standby traffic manager module 130-e receives retransmitted or new packets from the first network device 105-c after a failure of the principal traffic manager module 130-d, the standby traffic manager module 130-e may know which sequence number delta to apply in communicating with the second network device 145-c over Connection A′.

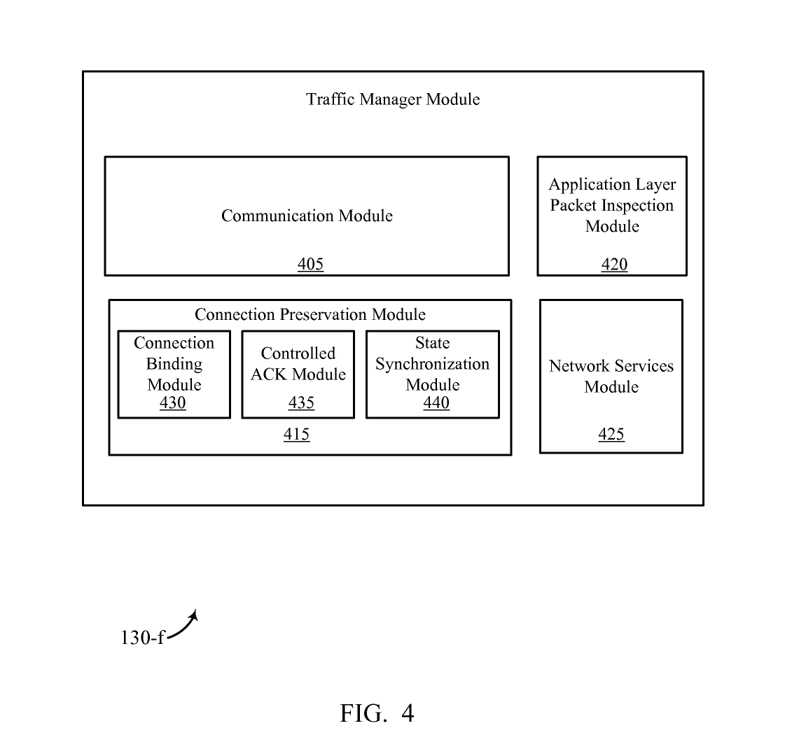

FIG. 4 is a block diagram of an example traffic manager module 130-f. The traffic manager module 130-f may be an example of the traffic manager modules 130 described above with respect to previous Figures. In certain examples, the same traffic manager module 130 may function as a principal traffic manager module 130 for a first set of connections and a standby traffic manager module 130 for a second set of connections. Alternatively, dedicated principal and standby traffic manager modules 130 may be used.

The traffic manager module 130-f of FIG. 3 may include a communication module 405 configured to establish a first connection (e.g., a TCP or other network connection) with a first network device and a second connection with a second network device. A connection preservation module 415 may be configured to preserve state information for a client or service connection such that the connection may be taken over by a standby traffic manager module in the event the principal traffic manager module 130-f fails.

The connection preservation module 415 may include a connection binding module 430 configured to establish a logical association between a first connection with a first network device and a second connection with a second network device where the traffic manager module 130-f acts as a proxy between the first network device and the second network device. The connection binding module 430 may maintain a stack of the sequence number deltas between the first connection and the second connection, as described above. The connection preservation module 415 may further include a controlled acknowledgment module 435 configured to delay transmitting acknowledgement messages for packets received from the first network device over the first connection until an acknowledgment message has been received from the second network device over the second connection for those packets. The connection preservation module 415 may further include a state synchronization module 440 configured to synchronize the state information about the first connection and the second connection to a standby traffic manager module at connection coupling and whenever a change in the sequence number delta occurs or one of the sequence numbers rolls over to an initial value. Additionally, the state synchronization module 440 may synchronize the state information about the first connection and the second connection to the standby traffic manager module each time the connection state (i.e., active, closed, one-side closed, etc.) changes.

The traffic manager module 130-f may also include an application layer packet inspection module 420 configured to inspect and analyze the application layer contents of packets associated with the network devices and a network services module 425 configured to take one or more performance enhancement actions based on the application layer content of the analyzed packets. In certain examples, the network services module 425 may take performance enhancement actions in response to other types of triggers or rules.

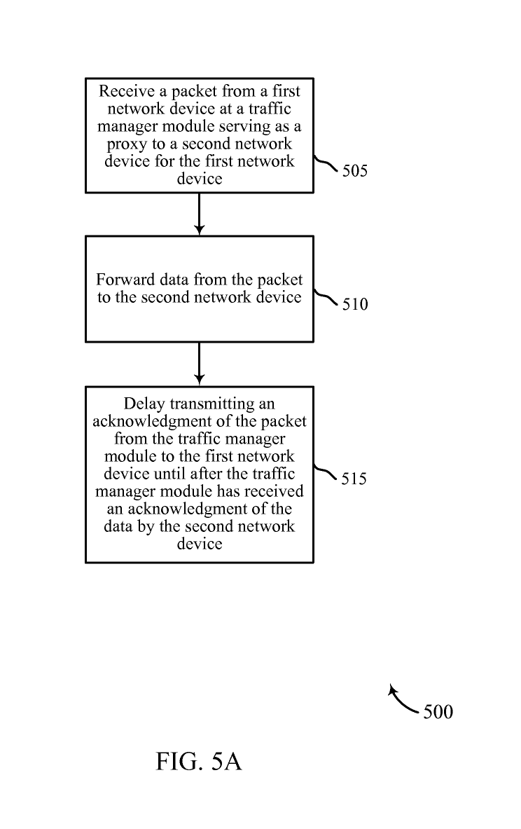

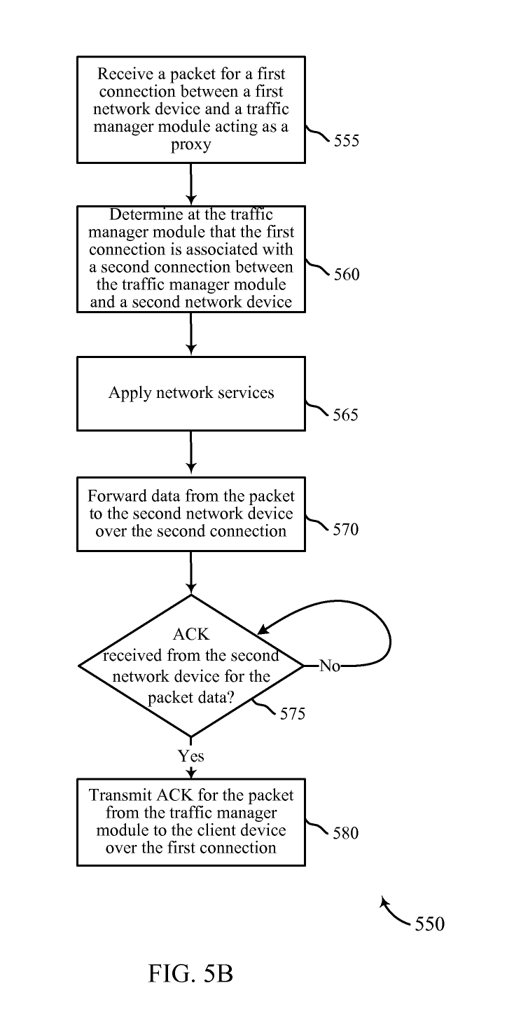

FIG. 5 is a flowchart diagram of an example method 500 of reducing the amount of state information synchronized between a principal traffic manager module and a standby traffic manager module in a network. The method may be performed by one or more of the traffic manager modules 130 described above with respect to previous Figures. At block 505, a packet may be received for a first connection between a first network device and a traffic manager module acting as a proxy. At block 510, it may be determined at the traffic manager module that the first connection is associated with a second connection between the traffic manager module and a second network device. At block 515, network services may be applied by the principal traffic manager module to the data transmitted over the first and second connections. At block 520, data from the packet may be forwarded to the second network device over the second connection. At block 525, it may be determined whether an acknowledgment message has been received from the second network device for the packet data over the second connection. If no such acknowledgement message has been received over the second connection (block 525, NO), flow may remain at block 525. Note that the principal traffic manager module may continue to receive packets from the first network device while flow is at block 525. If the acknowledgement message has been received over the second connection for the packet data (block 525, YES), an acknowledgment message may be transmitted for the packet from the traffic manager module to the first network device over the first connection at block 530.

State Information Synchronization

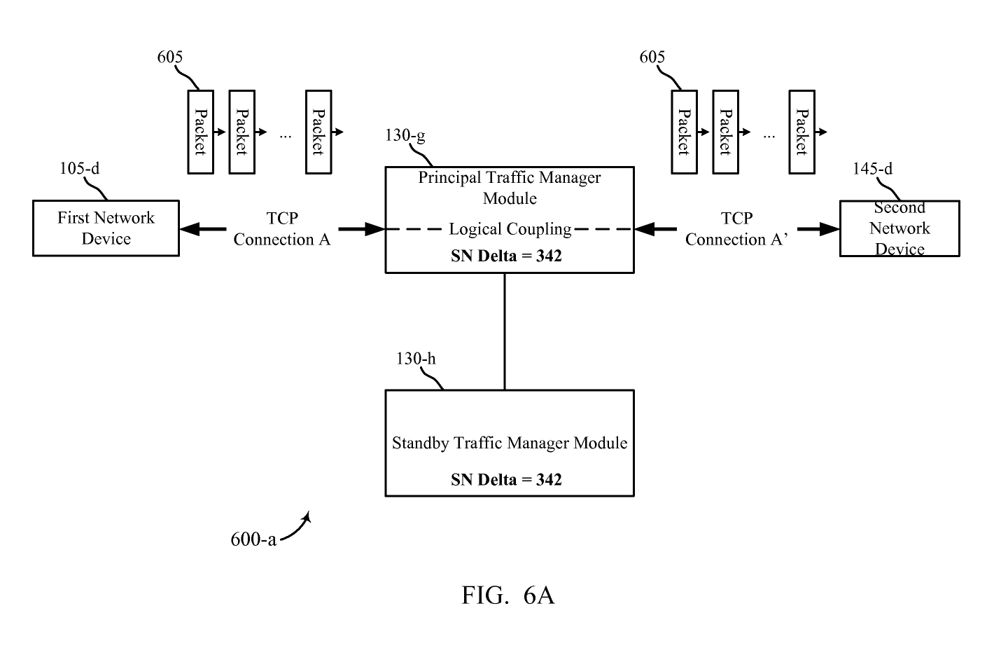

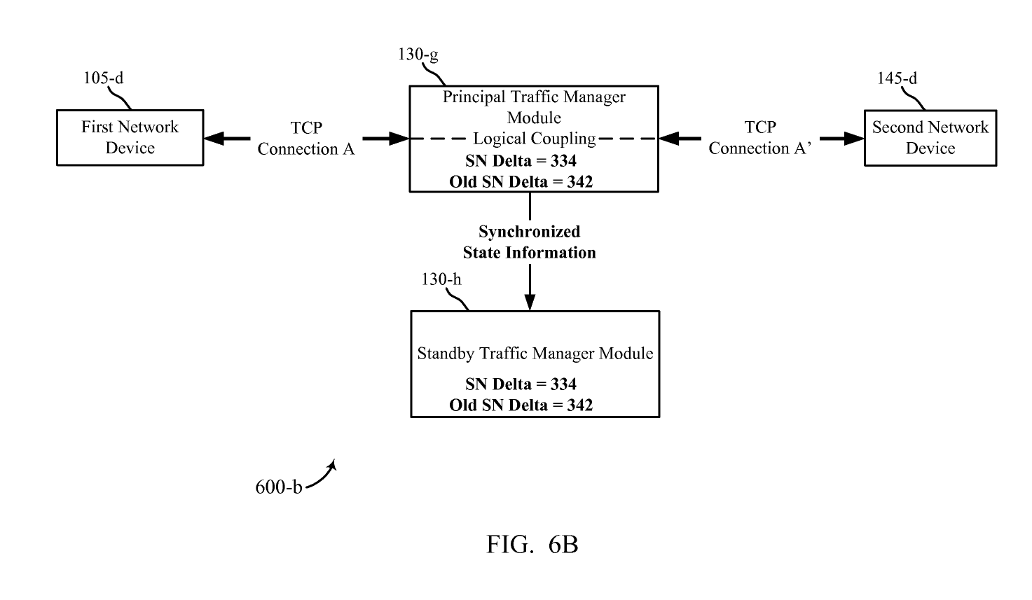

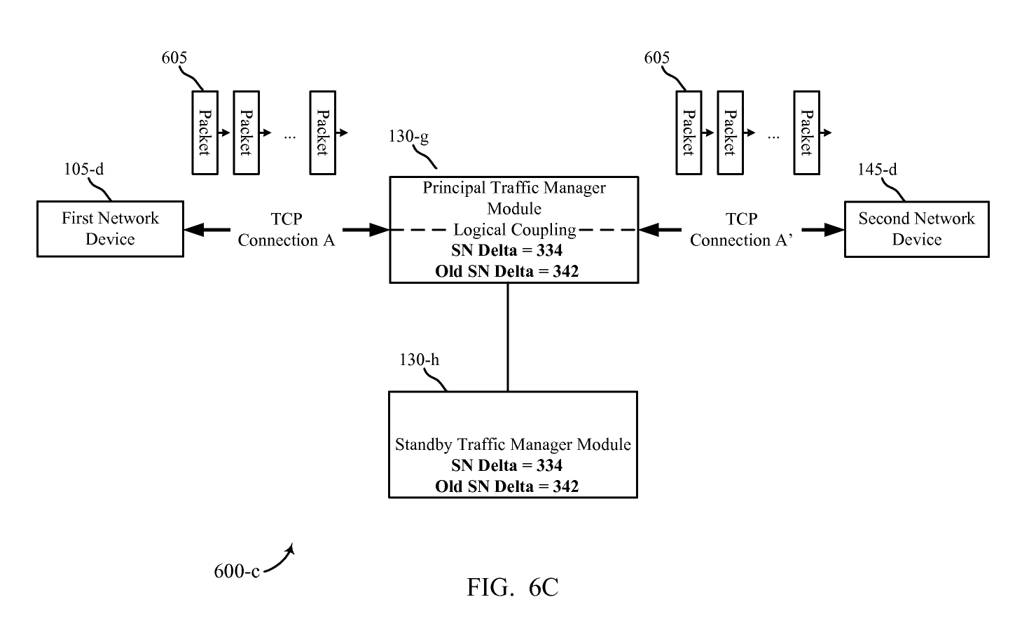

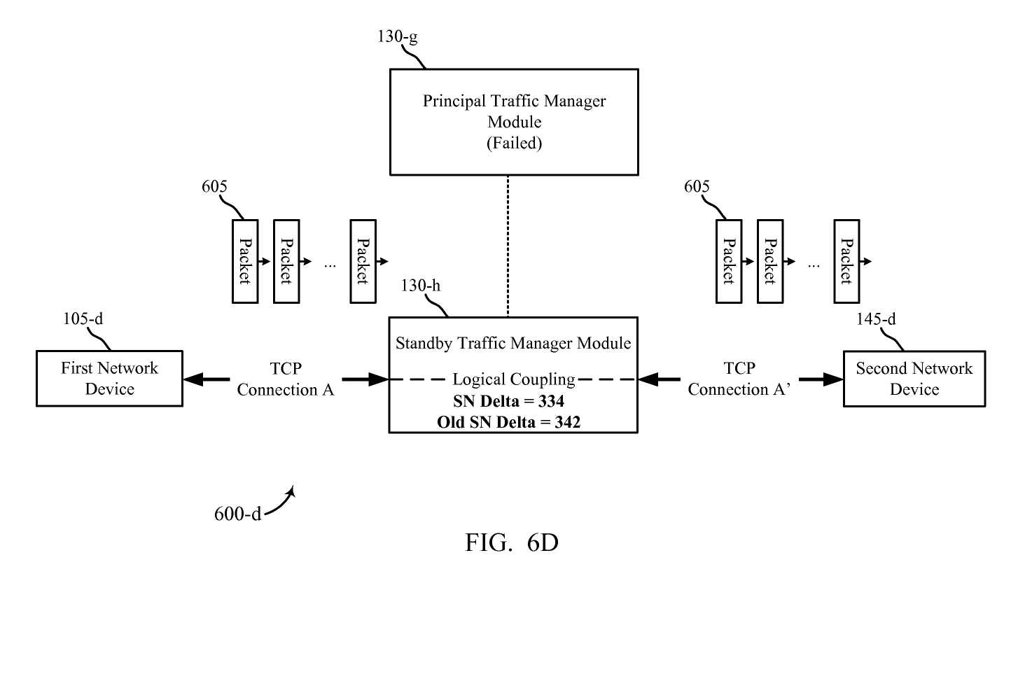

FIGS. 6A-6D are diagrams of the exchange of information in an example system 600 at different points in time. The system 600 of FIGS. 6A-6D may be an example of one or more of the systems 100, 200, 300 described above with reference to the previous Figures. The system 600 of the present example may include a principal traffic manager module 130-g, a standby traffic manager module 130-h, a first network device 105-d, and a second network device 145-d.

As in previously described examples, the principal traffic manager module may establish a first TCP connection (“Connection A”) with the first network device 105-d and at least a second TCP connection (“Connection A′”) with the second network device 145-d such that the principal traffic manager module 130-g functions as a proxy between the first network device 105-d and the second network device 145-d. Accordingly, the principal traffic manager module may logically couple Connection A with Connection A′ and store a stack of current and former sequence number deltas between Connection A and Connection A′. The standby traffic manager module 130-h may be in communication with the principal traffic manager module 130-g and provide redundant traffic manager module capabilities to protect Connection A and Connection A′ in the event of a failover at the principal traffic manager module 130-g.

FIG. 6A shows the system 600 at a first point in time at which the first network device 105-d may transmit a number of packets 605 to the principal traffic manager module 130-g, where the packets 605 are intended for the second network device 145-d. The principal traffic manager module 130-g may update the sequence number in the packets 605 using the current sequence number delta and forward the packets 605 on to the second network device 145-d. In the present example, the current sequence number delta at FIG. 6A is 342.

Through the use of controlled acknowledgment message transmissions as described above with respect to FIGS. 3-5, the principal traffic manager module 130-g need not synchronize buffered data for Connection A and Connection A′ to the standby traffic manager module 130-h. Thus, as long as the standby traffic manager module 130-h has access to the current sequence number delta stack and the basic connection information and parameters for Connection A and Connection A′, state information for these connections need not be synchronized to the standby traffic manager module 130-h whenever data is received or transmitted at the principal traffic manager module 130-g. Accordingly, assuming the current sequence number delta stack has already been synchronized with the standby traffic manager module 130-h, packets 605 may be transmitted and received over Connection A and Connection A′ without further synchronization until there is a change in the current sequence number delta, a rollover of a sequence number to an initial value, or a change in connection state (i.e., active, closed, one-side closed, etc.) at the primary traffic manager module 130-g.

FIG. 6B shows the system 600 at a point in time where the sequence number delta between Connection A and Connection A′ has changed from 342 to 334. The sequence number delta between the connections may change for a variety of reasons. One common cause of a change in the sequence number delta may be the local processing of received packets 605 at the principal traffic manager module 130-g. For example, the principal traffic manager module 130-g may receive certain packets 605 over Connection A that are processed locally at the principal traffic manager module 130-g and not forwarded to the second network device 145-d over Connection A′. Alternatively, the principal traffic manager may apply transformations on the packet data that may result in altering the packet contents and thus resulting in a change in the size of the packet data. This change in sequence number delta may trigger the principal traffic manager module 130-g to synchronize state information for the connections to the standby traffic manager module 130-h. The synchronized state information may include the updated sequence number delta stack along with the start and end sequence numbers of the bytes that were transformed. In addition, the transformed data may be synchronized as well. In certain examples, the synchronized state information may also include other connection information or parameters.

Upon detecting the change in sequence number delta, the principal traffic manager module 130-g may pause Connection A and Connection A′ until the updated stack of sequence number deltas has been transmitted to and acknowledged by the standby traffic manager module 130-h.

FIG. 6C shows the system 600 after the standby traffic manager module 130-h has the latest sequence number delta stack for the two connections and communication over the connections has resumed. After receiving the latest sequence number delta stack for the two connections, the standby traffic manager module 130-h may be again in position to assume Connection A and Connection A′ in the event of a failover at the principal traffic manager module 130-g.

FIG. 6D shows the system 600 after a failure of the principal traffic manager module 130-g. The standby traffic manager module 130-h may take over proxy operations for Connection A and Connection A′. Using the synchronized state information, the standby traffic manager module 130-h may manage the logical coupling between the connections such that from the point of view of the first network device 105-d and the second network device 145-d, nothing has changed.

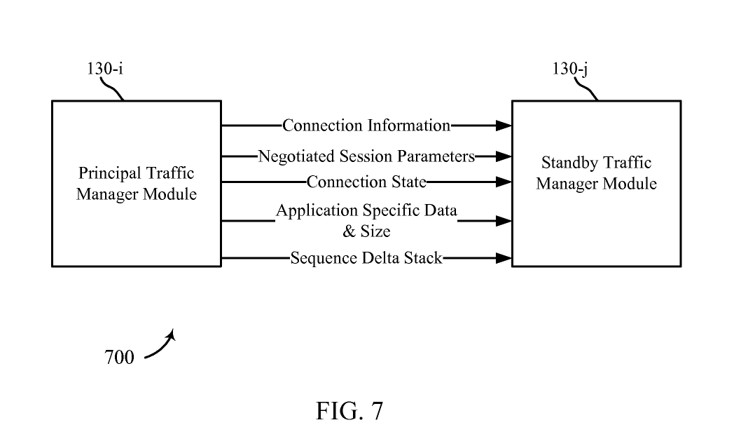

FIG. 7 is a diagram of an example state notification synchronization operation from a principal traffic manager module 130-i to a standby traffic manager module 130-j in a system 700. The principal traffic manager module 130-i and the standby traffic manager module 130-j may be examples of one or more of the principal and standby traffic manager modules 130 described in the previous Figures.

The principal traffic manager module 130-i may initiate a state notification to the standby traffic manager module 130-j upon logical pairing of the connections and in response to detecting a change in the sequence number delta between two logically paired connections (e.g., TCP Connection A and TCP Connection A′ as shown in previous Figures). In certain examples, state notifications may occur more frequently. As shown in FIG. 7, the state notification may include connection information (e.g., IP addresses, port numbers, etc.) for the logically paired connections, negotiated session parameters (e.g., window scaling, timestamps, maximum segment size, etc.) for the logically paired connections, a state (e.g., active, closed, etc.) of each logically paired connection, application specific data and a size associated with the application specific data, and the current sequence delta stack.

In certain examples, the entire sequence number delta stack may be synchronized instead of only the current sequence number delta to allow for the transmission of out-of-order acknowledgment messages or other out-of-order transmissions over the connections after the failure of the principal traffic manager module 130-i. For example, after the standby traffic manager module 130-j has assumed a set of logically paired connections with a current sequence number delta, the standby traffic manager module 130-j may receive a number of out-of-order acknowledgment messages over one of the connections where a previous sequence number delta applies. Thus, based on the sequence numbers of packets received over the connections, the standby traffic manager module 130-j may look up the applicable sequence number delta in the sequence number delta stack and modify the packets containing the acknowledgment messages for forwarding according to the applicable sequence number delta. In certain examples, portions of the sequence number delta stack that are no longer applicable to any packets may be removed from the sequence number delta stack that is synchronized to the standby traffic manager module 130-j.

In certain examples, when a change is detected in the sequence number delta for the connections, the new sequence number delta stack may be transmitted to the standby traffic manager module 130-j in a state notification prior to updating the sequence number delta stack locally at the principal traffic manager module 130-i. Doing so may ensure that if failover occurs at the principal traffic manager module 130-i, the failover logic at the standby traffic manager module 130-j may prevent data corruption at the connections.

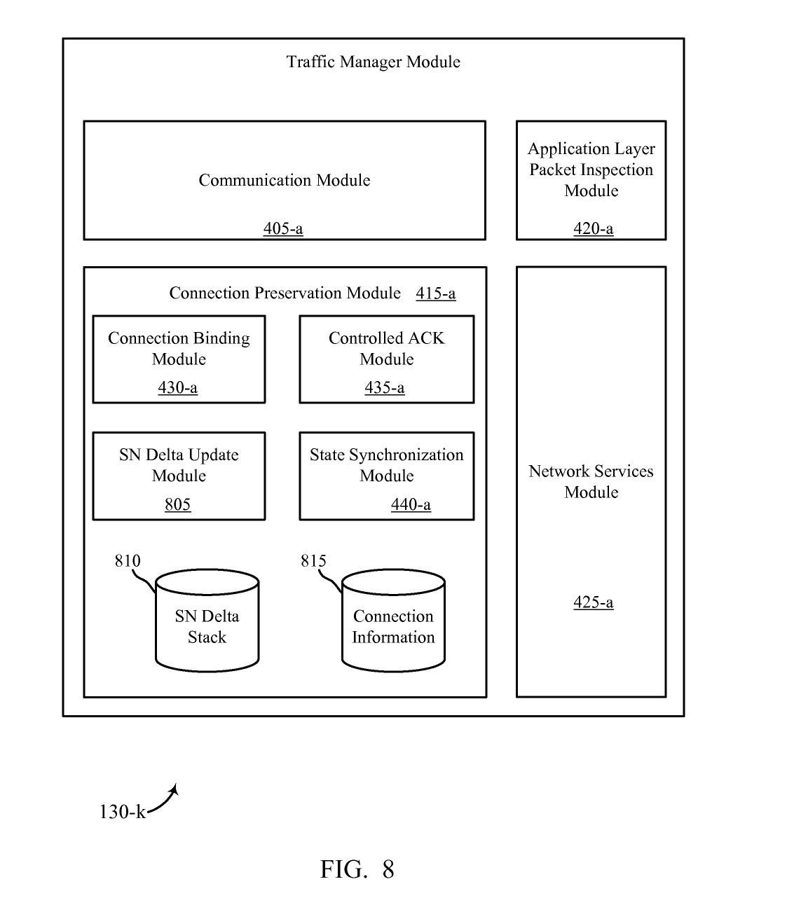

FIG. 8 is a block diagram of an example traffic manager module 130-k. The traffic manager module 130-k may be an example of one or more of the traffic manager modules 130 described above with respect to previous Figures. In certain examples, the same traffic manager module 130 may function as a principal traffic manager module 130 for a first set of connections and a standby traffic manager module 130 for a second set of connections. Alternatively, dedicated principal and standby traffic manager modules 130 may be used.

The traffic manager module 130-k of FIG. 8 may include a communication module 405-a configured to establish a first connection (e.g., a TCP or other network connection) with a first network device and a second connection with a second network device. A connection preservation module 415-a may be configured to preserve state information for a pair of logically paired client and service connections such that the connections may be taken over by a standby traffic manager module in the event the principal traffic manager module 130-k fails.

The connection preservation module 415-a may include a connection binding module 430-a configured to establish a logical association or pairing between a first connection with a first network device and a second connection with a second network device where the traffic manager module 130-k acts as a proxy between the first network device and the second network device. The connection preservation module 415-a may further include a controlled acknowledgment module 435-a configured to delay transmitting acknowledgement messages for packets received from the first network device over the first connection until an acknowledgment message has been received from the second network device over the second connection for those packets.

The connection preservation module 415-a may also include a sequence number delta update module 805 may track the difference between sequence numbers in packets transmitted over the first connection and packets transmitted over the second connection. As sequence number deltas change for the logically paired connections, the sequence number delta update module 805 may update a sequence number delta stack 810. In certain example, a separate sequence number delta stack 810 may be maintained for each set of logically paired connections for which proxy service is implemented at the traffic manager module 130-k. In certain examples, sequence number delta entries may be removed from the sequence number delta stack 810 in a response to a determination that those entries are no longer applicable to packets transmitted over the logically paired connections.

The connection preservation module 415-a may further include a state synchronization module 440-a configured to synchronize the state information about logically paired first and second connections to a standby traffic manager module whenever a change in the sequence number delta occurs. The state information synchronized to the standby traffic manager module may include the current sequence number delta stack 810 in addition to data about the connection (e.g., port numbers, IP addresses, other socket information, negotiated session parameters, connection or socket states, application specific data, etc.) stored in a connection information data store 815.

The traffic manager module 130-k may also include an application layer packet inspection module 420-a configured to inspect and analyze the application layer contents of packets associated with the logically paired first and second connections and a network services module 425-a configured to take one or more performance enhancement actions based on the application layer content of the analyzed packets. In certain examples, the network services module 425-a may take performance enhancement actions in response to other types of triggers or rules.

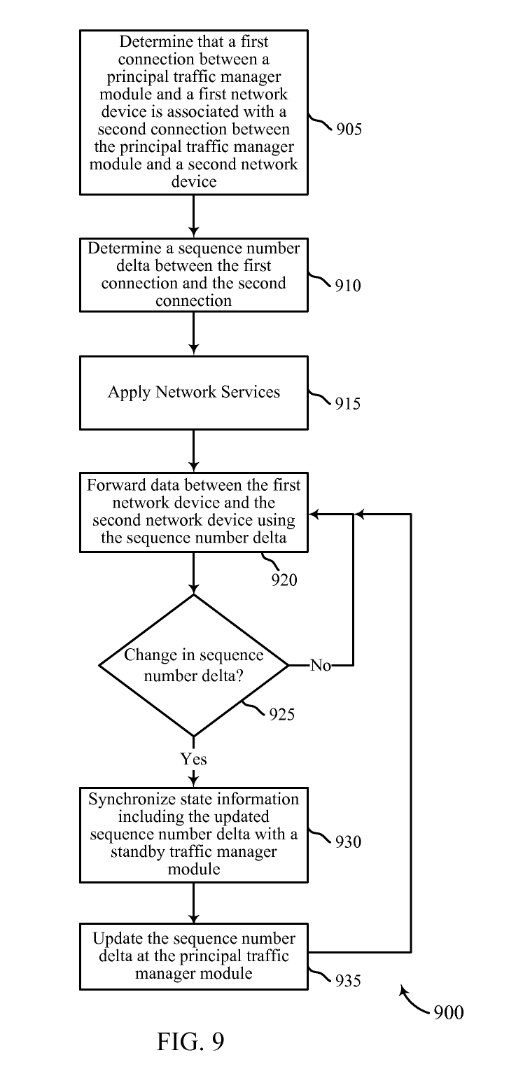

FIG. 9 is a flowchart diagram of an example method 900 of synchronizing state information between a principal traffic manager module and a standby traffic manager module. The method 900 may be performed by one or more of the traffic manager modules 130 described above with respect to previous Figures. At block 905, it may be determined that a first connection between a principal traffic manager module and a first network device is associated with a second connection between the principal traffic manager module and a second network device. In certain examples, the two connections may be associated with each other in that the principal traffic manager module acts as a proxy between the first network device and the second network device. At block 910, a sequence number delta may be determined between packets for the first connection and packets for the second connection. At block 915, network services may be applied to the first connection and/or the second connection. At block 920, data may be forwarded between the first network device and the second network device over the first and second connections by modifying the packets using the sequence number delta at the principal traffic manager module.

At block 925, it may be determined whether a change in sequence number delta has occurred. If no change occurs (block 950, No), flow may return to block 920. If a change in sequence number delta has occurred (block 925, Yes), state information for the first and second connections may be synchronized with a standby traffic manager module at block 930. Additionally or alternatively, the state information for the first and second connections may be synchronized with the standby traffic manager module when the sequence number for one of the connections rolls over to an initial value, or when a connection state (i.e., active, closed, one-side closed, etc.) changes. The state information may include the updated sequence number delta. At block 935, the sequence number delta may be updated at the principal traffic manager module.

Connection Recreation at a Standby Traffic Manager Module

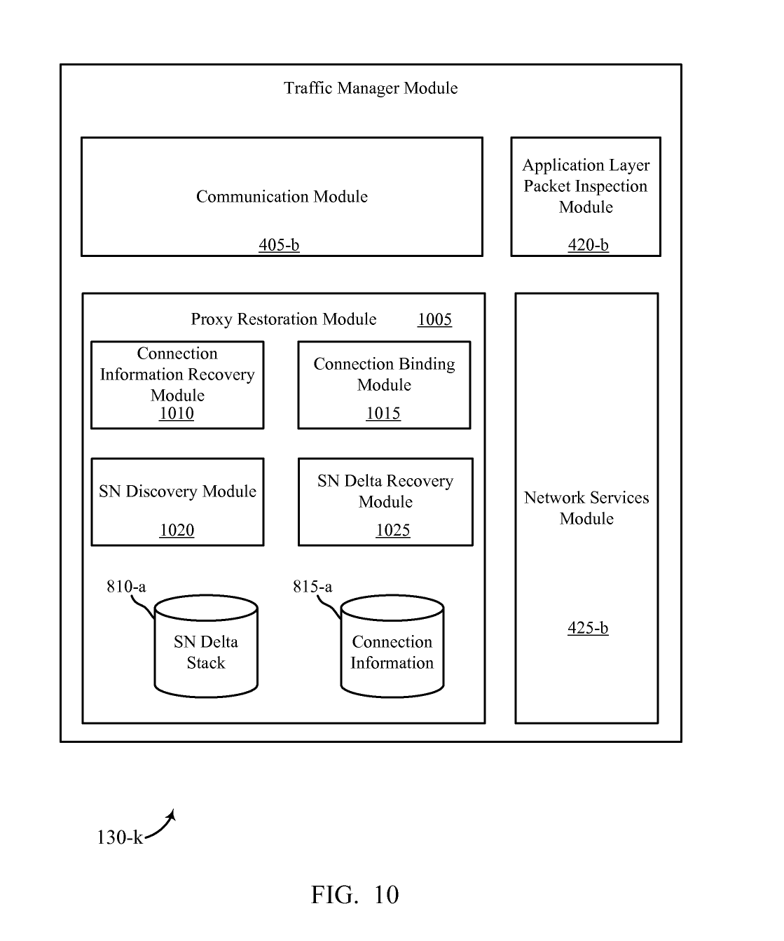

FIG. 10 is a block diagram of an example standby traffic manager module 130-k. The standby traffic manager module 130-k may be an example of one or more of the traffic manager modules 130 described above with respect to previous Figures. In certain examples, the same traffic manager module 130 may function as a principal traffic manager module 130 for a first set of connections and a standby traffic manager module 130 for a second set of connections. Alternatively, dedicated principal and standby traffic manager modules 130 may be used.

In the event of a failure at a principal traffic manager module 130, the standby traffic manager module 130-k may recreate and take over TCP or other connections maintained by the principal traffic manager module 130. In cases where the principal traffic manager module 130 acted as a proxy between a first network device and a second network device, the standby traffic manager module 130-k of the present example may recreate and continue this proxy functionality without any perceived change from the perspective of the first network device or the second network device.

The standby traffic manager module 130-k of FIG. 10 may include a communication module 405-b configured to establish connections to communicate with a first network device and a second network device, and a proxy restoration module 1005 configured to use synchronized state information from a principal traffic manager module to 1) restore a first connection to a first network device, 2) restore a second connection to a second network device, and 3) restore a proxy relationship between the first connection and the second connection.

The proxy restoration module 1005 may include a connection information recovery module 1010, a connection binding module 1015, a sequence number discovery module 1020, a sequence number delta recovery module 1025, a sequence number delta stack 810-a, and a connection information data store 815-a.

In the event of a failover at the principal traffic manager module 130, the connection information recovery module 1010 may access connection information from the connection information data store 815-a to identify data and parameters for reestablishing the first connection and the second connection. The connection information may include port numbers, IP addresses, other socket information, negotiated session parameters, connection or socket states, application specific data, or other applicable connection information. Using this connection information, the first and second connections may be restored to the communication module 405-b. Alternatively, the connection restoration can happen with every state synchronization message, but the restored connection will remain passive until the failover happens. The connection binding module 1015 may logically associate or pair the first connection with the second connection to reestablish the proxy relationship between the first and second connections.

The sequence number discovery module 1020 may discover the current sequence number associated with each of the connections in one or more ways. In one example, the sequence number discovery module 1020 may send false acknowledgment messages to the first network device over the first connection or to the second network device over the second connection to trigger the first network device or second network device to transmit any additional data that is buffered and ready to transmit over its respective connection. Once new packets are received over the first and second connections, the sequence number discovery module 1020 may ascertain the current sequence number associated with each connection. Additionally or alternatively, the sequence number discovery module 1020 may wait for packets to be transmitted over the first or second connection as a matter of due course and discover the current sequence number for each connection as the packets are received at the traffic manager module 130-k.

The sequence number delta recovery module 1025 may recover a sequence number delta applicable to packets transmitted over the first connection and the second connection. The sequence number delta may be retrieved from the sequence number delta stack 810-a received from the principal traffic manager module.

In certain examples, the standby traffic manager module 130-k may also include an application layer packet inspection module 420-b configured to inspect and analyze the application layer contents of packets associated with the logically paired first and second connections and a network services module 425-b configured to take one or more performance enhancement actions based on the application layer content of the analyzed packets. In certain examples, the network services module 425-b may take performance enhancement actions in response to other types of triggers or rules.

In certain examples, the standby traffic manager module 130-k may demote application layer (layer 7) connections to transport layer (layer 4) connections upon failover. This demotion may be done to conserve resources at the standby traffic manager module 130-k or in situations where certain application-specific data is not synchronized to the standby traffic manager module 130-k. Alternatively, layer 7 connections may be maintained upon failover.

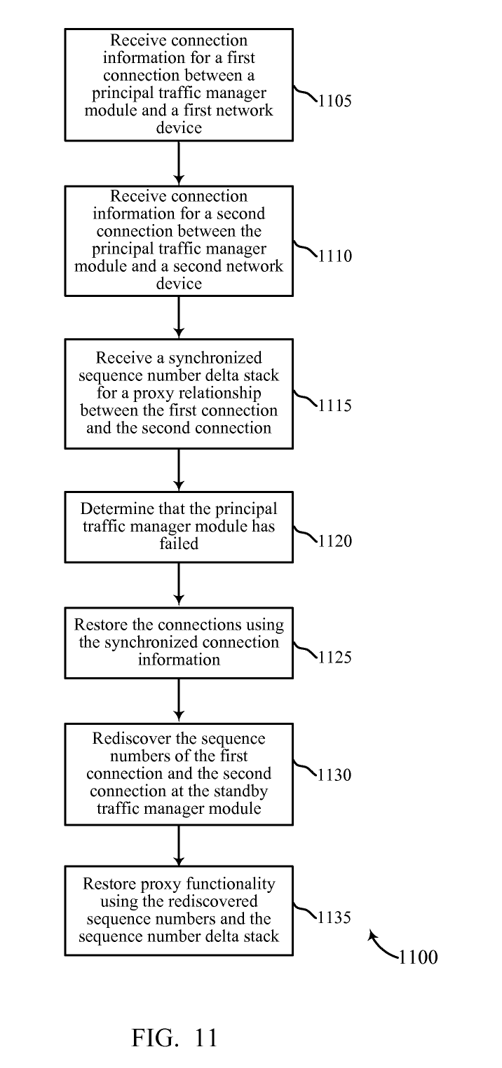

FIG. 11 is a flowchart diagram of an example method 1100 of restoring proxy connections at a standby traffic manager module based on state information received from a principal traffic manager module. The method 1100 may be performed by one or more of the traffic manager modules 130 described above with respect to previous Figures.

At block 1105, connection information for a first connection between a principal traffic manager module and a first network device may be received at the standby traffic manager module. The connection information may include port numbers, IP addresses, other socket information, negotiated session parameters, connection or socket states, application specific data, or other applicable connection information. At block 1110, similar connection information may be received at the standby traffic manager module for a second connection between the principal traffic manager and a second network device. At block 1115, a synchronized sequence number delta stack may be received for a proxy relationship between the first connection and the second connection.

At block 1120, it may be determined that the principal traffic manager module has failed. At block 1125, the connections may be restored using the synchronized connection information. At block 1130, the current sequence numbers of the first and second connections may be discovered at the standby traffic manager module. The current sequence numbers may be discovered by transmitting phony acknowledgment messages over the first or second connection to trigger the transmission of data packets over the first or second connection. Alternatively, the current sequence numbers may be discovered by waiting for the first network device or second network device to transmit data packets over the first or second connection on its own. At block 1135, the proxy functionality may be restored by logically pairing the connections based on the received sequence number delta stack, and the rediscovered sequence numbers.

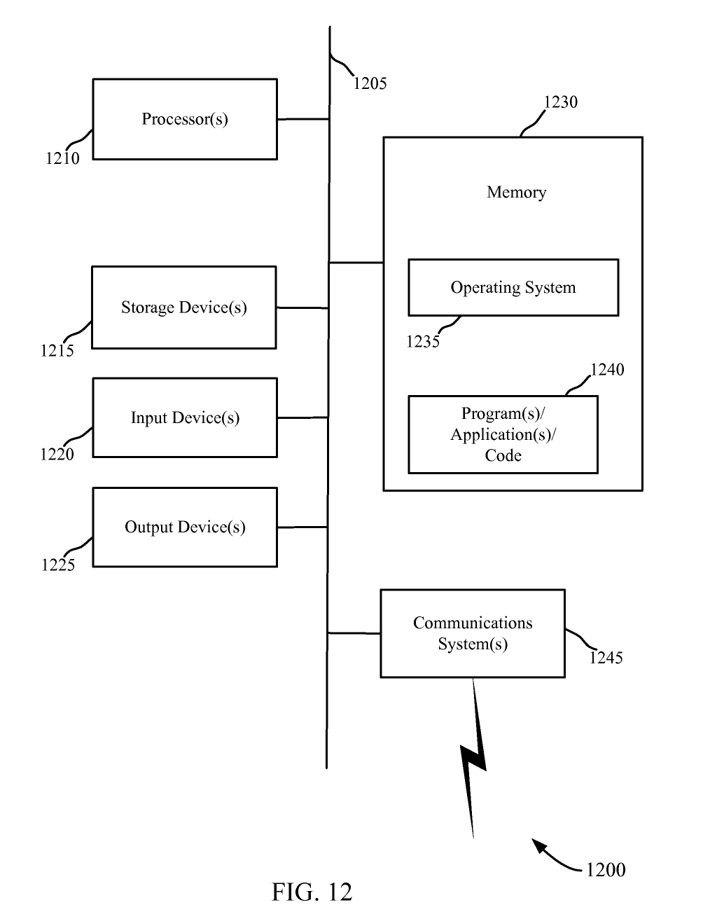

A device structure 1200 that may be used to implement a traffic manager module 130, a network device 105 or 145, a service 120, 125, or 135 or other computer-based devices described herein, is illustrated with the schematic diagram of FIG. 12. This drawing broadly illustrates how individual system elements of each of the aforementioned devices may be implemented, whether in a separated or more integrated manner. The exemplary structure is shown comprised of hardware elements that are electrically coupled via bus 1205, including processor(s) 1210 (which may further comprise a DSP or special-purpose processor), storage device(s) 1215, input device(s) 1220, and output device(s) 1225. The storage device(s) 1215 may be a machine-readable storage media reader connected to any machine-readable storage medium, the combination comprehensively representing remote, local, fixed, or removable storage devices or storage media for temporarily or more permanently containing computer-readable information. The communications systems interface 1245 may interface to a wired, wireless, or other type of interfacing connection that permits data to be exchanged with other devices. The communications system(s) interface 1245 may permit data to be exchanged with a network.

The structure 1200 may also include additional software elements, shown as computer-readable program code being currently located within working memory 1230, including an operating system 1235 and other code 1240, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

The components described in the present disclosure may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of managing network communications, comprising:
receiving a packet from a first network device at a traffic manager module serving as a proxy to a second network device for the first network device;
forwarding data from the packet to the second network device; and
delaying transmitting an acknowledgment of the packet from the traffic manager module to the first network device until after the traffic manager module has received an acknowledgment of the data by the second network device.

2. The method of claim 1, wherein the traffic manager module comprises a first traffic manager module, the method further comprising:
tracking a sequence number delta at the first traffic manager module between a first connection with the first network device and a second connection with the second network device;
detecting a change in the sequence number delta; and
synchronizing a state of the first traffic manager module with a second traffic manager module in response to the detected change in the sequence number delta.

3. The method of claim 2, further comprising:
synchronizing the state of the first traffic manager module with the second traffic manager module in response to one or more of: a rollover of a sequence number of one of the connections to an initial value or a change in a connection state of one of the connections.

4. The method of claim 2, further comprising:
storing a stack of sequence number deltas between the first connection and the second connection at the first traffic manager module.

5. The method of claim 4, wherein synchronizing the state of the first traffic manager module with the second traffic manager module comprises:
synchronizing the stack of sequence number deltas with the second traffic manager module.

6. The method of claim 2, further comprising:
refraining, in response to the change in the sequence number delta, from forwarding data between the first network device and the second network device until the state of the first traffic manager module has been synchronized with the state of the second traffic manager module.

7. The method of claim 2, further comprising:
storing a logical coupling between the first connection and the second connection at the first traffic manager module.

8. The method of claim 7, wherein synchronizing the state of the first traffic manager module with the second traffic manager module comprises:
synchronizing the logical coupling between the first connection and the second connection with the second traffic manager module.

9. The method of claim 2, further comprising:
storing Quality of Service (QoS) information related to the first connection and the second connection at the first traffic manager module.

10. The method of claim 9, wherein synchronizing the state of the first traffic manager module with the second traffic manager module comprises:
synchronizing the QoS information related to the first connection and the second connection with the second traffic manager module.

11. A traffic manager module, comprising:
at least one processor; and
a memory communicably coupled with the at least one processor, the memory configured to store code that, when executed by the at least one processor, causes the at least one processor to:
receive a packet from a first network device, the traffic manager module serving as a proxy to a second network device for the first network device;
forward data from the packet to the second network device; and
delay transmitting an acknowledgment of the packet from the traffic manager module to the first network device until after the traffic manager module has received an acknowledgment of the data by the second network device.

12. The traffic manager module of claim 11, wherein:
the traffic manager module comprises a first traffic manager module; and
the code causes the at least one processor to:
track a sequence number delta at the first traffic manager module between a first connection with the first network device and a second connection with the second network device;
detect a change in the sequence number delta; and
synchronize a state of the first traffic manager module with a second traffic manager module in response to the detected change in the sequence number delta.

13. The traffic manager module of claim 12, wherein the code causes the at least one processor to:
synchronize the state of the first traffic manager module with the second traffic manager module in response to one or more of: a rollover of a sequence number of one of the connections to an initial value or a change in a connection state of one of the connections.

14. The traffic manager module of claim 12, wherein the code causes the at least one processor to:
store a stack of sequence number deltas between the first connection and the second connection at the first traffic manager module.

15. The traffic manager module of claim 14, wherein the code causes the at least one processor to synchronizing the state of the first traffic manager module with the second traffic manager module by:
synchronizing the stack of sequence number deltas with the second traffic manager module.

16. The traffic manager module of claim 12, wherein the code causes the at least one processor to:
refrain, in response to the change in the sequence number delta, from forwarding data between the first network device and the second network device until the state of the first traffic manager module has been synchronized with the state of the second traffic manager module.

17. The traffic manager module of claim 12, wherein the code causes the at least one processor to:
store a logical coupling between the first connection and the second connection at the first traffic manager module.

18. The traffic manager module of claim 17, wherein the code causes the at least one processor to synchronize the state of the first traffic manager module with the second traffic manager module by:
synchronizing the logical coupling between the first connection and the second connection with the second traffic manager module.

19. The traffic manager module of claim 12, wherein the code causes the at least one processor to:
store Quality of Service (QoS) information related to the first connection and the second connection at the first traffic manager module.

20. The traffic manager module of claim 19, wherein the code causes the at least one processor to synchronize the state of the first traffic manager module with the second traffic manager module by:
synchronizing the QoS information related to the first connection and the second connection with the second traffic manager module.

21. A tangible computer-readable medium comprising computer-readable program code stored thereon, which is configured to cause at least one processor to:
receive a packet from a first network device at a traffic manager module serving as a proxy to a second network device for the first network device;
forward data from the packet to the second network device; and
delay transmitting an acknowledgment of the packet from the traffic manager module to the first network device until after the traffic manager module has received an acknowledgment of the data by the second network device.

22. The computer program product of claim 21, wherein:
the traffic manager module comprises a first traffic manager module; and
the computer-readable program code is further configured to cause at least one processor to:
track a sequence number delta at the first traffic manager module between a first connection with the first network device and a second connection with the second network device;
detect a change in the sequence number delta; and
synchronize a state of the first traffic manager module with a second traffic manager module in response to the detected change in the sequence number delta.
